(19) United States
(12) Patent Application Publication
(10) Pub. No.: US 2017/0132052 A1
(43) Pub. Date: May 11, 2017

(54) ANALYZING AND AUTOMATING WORK-FLOW IN A COMPUTERIZED USER-INTERFACE

(71) Applicant: NICE-SYSTEMS LTD, Ra'anana (IL)

(72) Inventors: Omer ABRAMOVICI, Kfar Saba (IL); Iftach SMITH, Hod Hasharon (IL); David GEFFEN, Givat Shmuel (IL)

(73) Assignee: NICE-SYSTEMS LTD

(21) Appl. No.: 14/936,702

(22) Filed: Nov. 10, 2015

(51) Int. Cl. G06F 9/54; G06F 9/48

(52) U.S. Cl. CPC G06F 9/542; G06F 9/4881

(57) ABSTRACT

A computerized method for evaluating operational behavior on a computer is disclosed, comprising activating in the computer a code that intercepts events of operations on a user-interface of the computer and acquires data of the events, providing the data of the events to a computerized apparatus that automatically analyzes the data of the events by employing a pattern recognition algorithm that consequently identifies inefficient operations, summarizing and adapting for manual evaluation information related to the inefficient operations, and visually presenting on a presentation device the summarized and adapted information related to the inefficient operations to accomplish an objective and a computerized system for carrying out the computerized method.

### BACKGROUND

The present disclosure generally relates to work-flow, and more specifically to analyzing and automating work-flow.

Organizations such as call centers, banks, insurance companies or other institutions that have to handle data from multiple sources in various frameworks often, if not customarily, use an underlying support software for unifying or streamlining or simplifying data handling from multiple sources.

The unifying or streamlining of data handling is generally related to the user-interface aspects or operations and are accomplished by a mechanism of automating or mechanizing data exchange between applications or processes using the underlying support software and/or the operating system, generally without any modification to the applications or process.

Generally, the automation is carried out manually, possibly aided by suitable tools, such as to reduce manually identified inefficiencies as, for instance, repetitive operations or data exchange between applications. For example OpenSpan Inc. (http://www.openspan.com) and as further exemplified in https://www.youtube.com/user/OpenSpan.

### SUMMARY

One exemplary embodiment of the disclosed subject matter is a computerized method for evaluating operational behavior on a computer, comprising activating in the computer a code that intercepts events of operations on a user-interface of the computer and acquires data of the events, providing the data of the events to a computerized apparatus that automatically analyzes the data of the events by employing a pattern recognition algorithm that consequently identifies inefficient operations, summarizing and adapting for manual evaluation information related to the inefficient operations, and visually presenting on a presentation device the summarized and adapted information related to the inefficient operations to accomplish an objective.

In some embodiments, the method further comprises devising procedures configured for improving efficiency of operations on the user-interface of the computer.

In some embodiments, the method further comprises incorporating the procedures on the computer for automating the operations on the user-interface of the computer.

Another exemplary embodiment of the disclosed subject matter is a computerized system for carrying out the method and/or parts thereof.

### BRIEF DESCRIPTION OF THE DRAWINGS

Some non-limiting exemplary embodiments or features of the disclosed subject matter are illustrated in the following drawings.

Identical or duplicate or equivalent or similar structures, elements, or parts that appear in one or more drawings are generally labeled with the same reference numeral and may not be repeatedly labeled and/or described.

References to previously presented elements are implied without necessarily further citing the drawing or description in which they appear.

FIG. 1 schematically illustrates a system with basic components and control for analyzing and automation work-flow in a computerized user-interface, according to exemplary embodiments of the disclosed subject matter;

FIG. 2 lists representative metadata of on-screen events, according to exemplary embodiments of the disclosed subject matter;

FIG. 3A illustrates a technical oriented variant of a portal, according to exemplary embodiments of the disclosed subject matter;

FIG. 3B illustrates a business oriented variant of a portal, according to exemplary embodiments of the disclosed subject matter;

FIG. 4 outlines operations for matching, according to exemplary embodiments of the disclosed subject matter;

FIG. 5A illustrates objects and metadata of messages as may be appreciated in the Microsoft Windows environment;

FIG. 5B illustrates relevant information regarding the present disclosure, messages that were intercepted and the patterns' meta data, samples and statistics objects and metadata of messages as may be appreciated in the Microsoft Windows environment; and

FIG. 5C illustrates objects for pattern analysis service employed in searching and parsing a database for new patterns as may be appreciated in the Microsoft Windows environment.

### DETAILED DESCRIPTION

In the context of the present disclosure, without limiting, referring to intercepting events or operations or activities implies programmatically identifying occurrences of events or operations and identifying and, at least possibly or if necessitated, acquiring data of or associated with the events or the operations such as metadata thereof.

In the context of the present disclosure reference is made to Microsoft Windows (Microsoft Inc.) as an example without precluding other environments such as Android (Google Inc.) or Linux (The Linux Foundation).

In the context of the present disclosure, without limiting, a real-time integration, or RTI, refers to a mechanism and/or infrastructure for integration or unifying data entry or data exchange between applications or processes, thus eliminating or at least reducing inefficient operations by a user such as repetitive and/or unnecessary and/or redundant operations, generally in a framework or environment of a user-interface (UI) such as a Graphical User-interface (GUI).

The real-time integration operates transparently outside the applications or processes without having to modify and/or program in the source language level. In some cases the real-time integration operates in an event-driven manner where operation are captured and contents or metadata thereof are analyzed and/or processed.

For example, events of data operations such as read/write or of entry or display fields in one application are captured or intercepted and metadata thereof are identified or recorded, and when corresponding operations of fields in another application are activated the events thereof are captured and the corresponding recorded data are inserted as if t actually keyed-in or otherwise inputted, optionally after some preprocessing such as formatting.

In the context of the present disclosure, without limiting, the term ‘inefficiency’ or ‘inefficient’ with respect to data handling implies or directed to occurrences of repetitive and/or superfluous and/or excessive and/or redundant operations for achieving a data handling goal in a user-interface environment.

In the context of the present disclosure, without limiting, the term ‘to better’ or ‘bettering’ with respect to real-time integration implies reducing inefficiencies or at least attempting to optimize data handling by adjusting or adapting the functionality and/or conduct of real-time integration according to identified and/or provided data handling behavior.

For brevity and clarity and unless otherwise specified or evident, in the present disclosure the term ‘client computer’ denotes a computer operative as a terminal or a station for interactive data handling, and accordingly the term ‘client’ denotes a user or a person interactively operating the client computer.

The client computer may be any type of computer such as a personal computer, a tablet computer any other device suitable for interactive data handling such as a smartphone.

In the context of the present disclosure, without limiting, the client computer is linked and/or linkable for data communications with other devices, particularly with a data processing computer denotes also as a server.

Essentially a client computer and a server may be of similar nature, though generally at least the server is configured for competently processing large amounts of data such as with more resources of data storage or special hardware or firmware or multiple processors.

In the context of the present disclosure, without limiting, the term ‘browser’ denotes a program or a service capable to present data arranged and formatted in a layout or organization amenable for interpreting and visual presentation, such as Web browsers of the art.

In the context of the present disclosure, without limiting, the term ‘on-screen’ such as on-screen activities or on-screen events, is directed to and/or is equivalent to user interface as, respectively, user-interface activities or user-interface events.

The terms cited above denote also inflections and conjugates thereof.

One technical problem dealt by the disclosed subject matter is automatically identifying inefficiencies in data handling by clients in user-interfaces of client computers.

One technical solution according to the disclosed subject matter is monitoring data handling operations of clients in client computers and identifying inefficiencies by analyzing the monitored operations. The monitoring is carried out by a code installed in the client computers and configured to capture user-interface events and collect at least some distinct characteristics thereof. For example, a string input, copy of specific data, copy from certain field, paste of specific data, paste at certain field, keyboard action as keydown and/or keyup clicks by mouse or finger on certain locations, navigation between application and at least optionally taking into account respective order thereof and/or order of usage thereof, or an indication of the application in which an operation was performed optionally also with indication of the operational mode of the application as well as, at least optionally, indication of idling or waiting.

Generally, monitoring data handling operations is performed by tracking and/or intercepting and/or identifying events of the operations and/or data thereof such as metadata of the events.

The monitoring of operations is an ongoing process where at certain times, such as periodically and/or responsive to the amount of freshly monitored events, the recently collected information as metadata of the events and/or other information or designations thereof is forwarded to a server. The server analyzes the operations as depicted by the events and evaluates inefficiencies. Optionally, a set of designated operations is provided that according to which inefficiencies or repetitions or other behavioral patterns are evaluated, thus reducing the amount of data for processing and expediting the process to identify patterns of certain interest.

The evaluation is performed based on pattern analytics or pattern recognition such as known in the art, for example, Sequential Pattern Mining as a branch of Structured Data Mining that is directed to finding statistically significant patterns between data samples that are sequentially provided.

In some embodiments, the monitoring and the collection of events' data is restricted to a certain domain or activities. For example, only activities related too sale or technical support are monitored, as for instance determined or judged by the applications involved such as CRM or a billing application. Consequently, in some embodiments or cases the monitoring and processing is improved, such as by reducing the amount of data for transfers and notably thus simplifying the pattern recognitions by focusing on relevant data only.

In some embodiments, the results of the patterns evaluation are summarized in a construct amenable for display and navigation, such as in an XML or JSON constructs that may be presented by custom or off-the-shelf browsers where the data may be appraised thus providing grounds for improvement. For example, ranking the most inefficient client or most inefficient group of clients or ranking the most efficient client thus deducing guidelines for other clients.

Another technical problem dealt by the disclosed subject matter is automatically automating or bettering real-time integration according to provided indications of inefficiencies in data handling.

Another technical solution according to the disclosed subject matter is analyzing the inefficient operations and identifying repetitive and/or superfluous operations. Subsequently, employing one or more algorithms such as heuristic and/or optimization oriented algorithms and/or link reversal and/or akin to reverse engineering. Consequently all or at least some of the unnecessary operations for a certain task are removed and a procedure such as a script is constructed with the necessary operations and may be provided to the client computers for automating the task. In some embodiments, the procedure is communicated to the client computers per se. Optionally or alternatively, the procedure is provided to the real-time integration which takes care to of the procedure and invocations thereof.

In some embodiments, the procedure is constructed as a template so that when the procedure is invoked the client is prompted to fill-in necessary data. Optionally or alternatively, the data is pre-filled so that the procedure may be run automatically with no intervention from the clients.

In some embodiments, at least some of the unnecessary operations for a certain task are replaced by other operations that eventually reach the operational goal of the clients, for example in a simplified or more straightforward manner.

A potential technical effect of the disclosed subject matter is client computers adapted for automatic user-interface operations avoiding repetitive and/or superfluous operations.

A general non-limiting overview of practicing the present disclosure is presented below. The overview outlines exemplary practice of embodiments of the present disclosure, providing a constructive basis for variant and/or alternative and/or divergent embodiments, some of which are subsequently described.

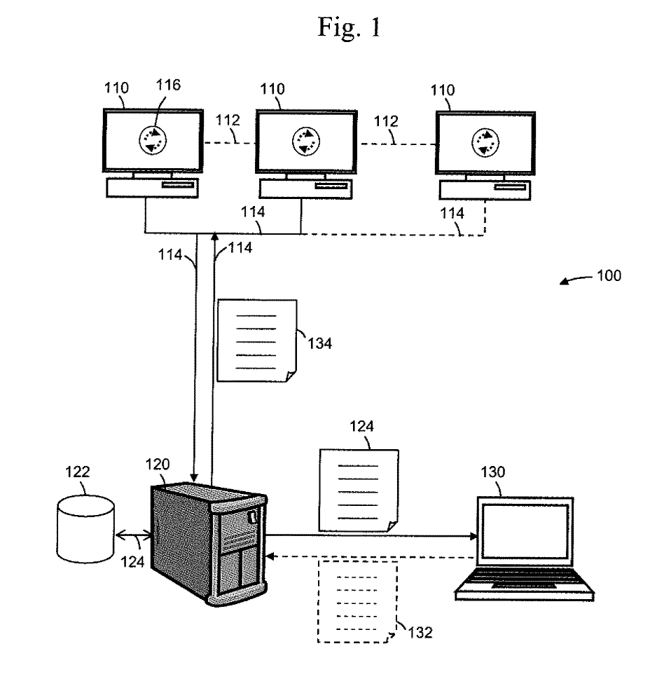

FIG. 1 schematically illustrates a system 100 with basic components and control for analyzing and automating work-flow in a computerized user-interface, according to exemplary embodiments of the disclosed subject matter.

System 100 comprises one or more computers as client computers, illustrated as three instances of a computer 110, representing any number of computer 110, as indicated by dashed lines 112.

System 100 further comprises a server, denoted also and illustrated as a server 120. Server 120 interacts with a storage device denoted also and illustrated as a storage 122 as schematically illustrated by a dual-arrow 124.

Server 120, at least in some embodiments, is configured for sufficiently effective storage and data exchange with processes operative or operating on server 120 such as with pattern recognitions or automation. For example, data is stored in one or more databases on server 120.

Any of computer 110 is linkable and/or linked to server 120 via a communications facilities that are generally represented by a network denoted also and schematically illustrated as network 114.

On any of computer 110 is installed a code or a program for on-going monitoring and intercepting on-screen activities such as by identifying data of events corresponding to the activities, the code or program denoted also as a monitoring code and illustrated schematically as a code 116.

Data of user-interface activities on any of computer 110 captured or intercepted by code 116, such as metadata or other information of user-interface events, is provided to server 120 such as by network 114 and stored in server 120 and/or storage 122. The data is provided to server 120 according to some regime such as by preset or determined portions, periodically, or responsive to the number of intercepted activities, not precluding practically continuous data streaming which is optionally buffered at server 120 and/or storage 122.

The data provided to server 120 is incorporated with previously obtained data (if any) to evaluate inefficient behavioral patterns of operations in on-screen data handling on instances of computer 110 by suitable algorithm and/or algorithms such as Sequential Pattern Mining, referred to collectively also as a pattern recognition algorithm or briefly as a pattern recognizer.

In some embodiments, the data provided to server 120 is incorporated with previously obtained data incrementally, that is, the recently received data is processes separately and the processing results are incorporated with previously processed results. Optionally or alternatively, other technique may be used, for example incorporating all the received data which are indiscriminately processed, or for example accumulating data to some extent and processing for results that are incorporated to previous results.

In some embodiments, evaluation of behavioral patterns is enumerated to a certain set or sub-set of behaviors, for example, repeated operations or idling.

The results of the pattern recognizer are summarized in a suitable manner for analysis. For example summary or summaries by categories such as by computer and/or users thereof, by efficiency or lack thereof, or in a manner amenable for trending such as progress in efficiency over time.

The results of the pattern recognizer are stored in a structure suitable for formatting and display. For example, in HTML structure which is ready for display by browsers, or XML or S-expressions or similar structures that organize the data in a manner that can be presented in various formats and organizations. Optionally or generally, the results are presented in a modifiable composition or layout and/or the contents of which may be searched for, at least partially.

By way of a non-limiting example, the results are stored in a document denoted as a patterns-document, also denoted and schematically illustrated as a patterns-document 124, which is directly or indirectly passed to a computer denoted as a supervisor-computer, also denoted and illustrated as a supervisor-computer 130, which visually presents contents of patterns-document 124 as a data portal or also a portal.

In some embodiments, the portal presents behavioral patterns in a ‘live’ mode, that is, data is refreshed and/or updated on the portal responsive to server 120 analyzing data obtained from the on-going monitoring and intercepting on-screen activities on any of computer 110, possibly with some practical and/or design delay such as due to communication economy or for convenient reading by operators. Refreshing or updating of the portal may be, for example, responsive to the portal inquiring server 120 and/or responsive to server 120 initiation of passing new or updated patterns-document 124 that is passed to the portal.

Passing a patterns-document such as patterns-document 124 to the portal is an exemplary method that represents other suitable techniques. For example, the portal may be in an intermittent and/or continuous data communication for updating the portal, or storage 122 may such as a database stored therein be accessible to the portal for inquiring or extraction of recent results. Optionally, the patterns-document such as patterns-document 124 may be used for transferring and/or sharing behavioral patterns with other computers and/or programs or with other organizations, such as for sharing experiences or shared or collaborated evaluations.

Generally, the portal is controlled and/or operated by one or more programs, referred to also as a portal suit, that handles data or document exchange with server 120 according to agreed upon timing regime and/or event driven operation.

Supervisor-computer 130 may be any type of computer. In some embodiments, one of the client computers, such as computer 110, may be used as or in a role of supervisor-computer 130. Generally, without limiting, the behavioral patterns are visually presented by a browser, though other programs and/or services may be used.

In some embodiments, based on the data collected from the client computers, the portal is configured to ‘play back’ the operations of and by users, possibly under controlled rate, thus enabling to review the behaviors of users as if they occurred right now.

In some embodiments, the portal may comprise or organized according to intended or expected audience thereof. For example, a system engineer or other technical personnel such as analysts may be interested in or may better benefit from more detailed or technical aspects than a business oriented personnel, where business oriented personnel may be more interested in concise summary which may yield business or behavioral conclusions than in technicalities.

In some embodiments, by evaluating the on-screen behavioral patterns of users such as from the presentation on supervisor-computer 130, various detrimental behavioral phenomena may be perceived, such as bottlenecks, increasing of inefficiencies and/or mistakes as time lapses, or unnecessary operations.

In order to counter the detrimental behaviors and streamline the on-screen operations one and/or a set of algorithms is devised and/or selected, collectively referred to as an automation algorithm, and employed on a suitable computer such as server 120 or a similar one. The automation algorithm employs technique such as to remove redundancies and/or reducing superfluous operations and/or avoiding bottlenecks and/or simplifying complex sequences.

In some embodiments the automation algorithm employs analytical and deterministic methods and/or recursive methods and/or heuristic techniques such as trial-and-error or reverse engineering from a determined goal.

The outcome of the automation algorithm is a procedure such as a script or any other procedural construct, generally operating according to preset and/or supplied parameters to adapt for the intended or required data handling task.

In some embodiments the procedure is provided to the client computers such as by incorporated in procedure the real-time integration applicable to the client computers.

By way or a non-limiting example, behavioral insights or perceptions obtained from the presentations on supervisor computer 130 are phrased or expressed or otherwise programmed by a script or guidelines, schematically illustrated as an insight document 132, which is provided to a server exemplified as server 120.

As described above, server 120 has access to the data of the user-interface activities of the client computes as captured by code 116, and by employing and/or applying the automation algorithm according to the insight document 132 server 120 generates a procedure such as a script, denoted and schematically illustrated as a script 134, which is provided to the client computers to automated or streamline the user-interface data handling thereof.

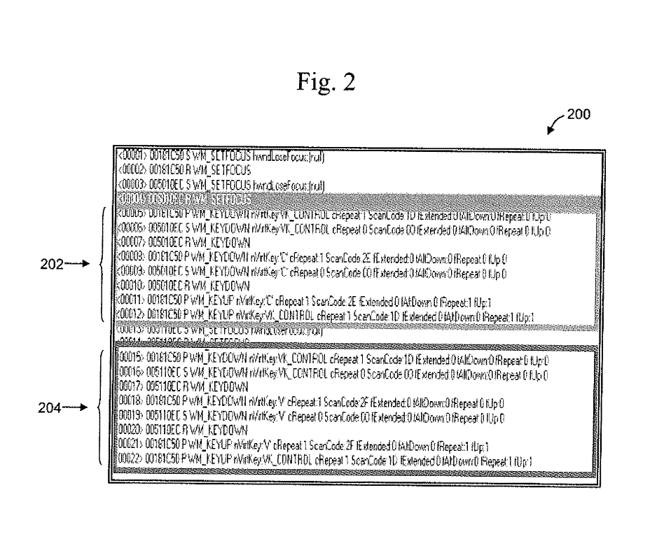

FIG. 2 lists representative metadata 200 of on-screen events, according to exemplary embodiments of the disclosed subject matter.

Metadata 200 is obtained from hooks in a Microsoft Windowsenvironment such as by SPY++(Microsoft Inc.) e.g. as described in https://msdn.microsoft.com/en-us/library/dd460756.aspx and may be interpreted from resources such as in https://msdn.microsoft.com/en-us/library/windows/desktop/ms644959(v=vs.85).aspx.

As represented, metadata 200 comprises metadata of ‘control/C’ (copy) and ‘control/V’ (paste) events as indicated by metadata 202 and metadata 204, respectively.

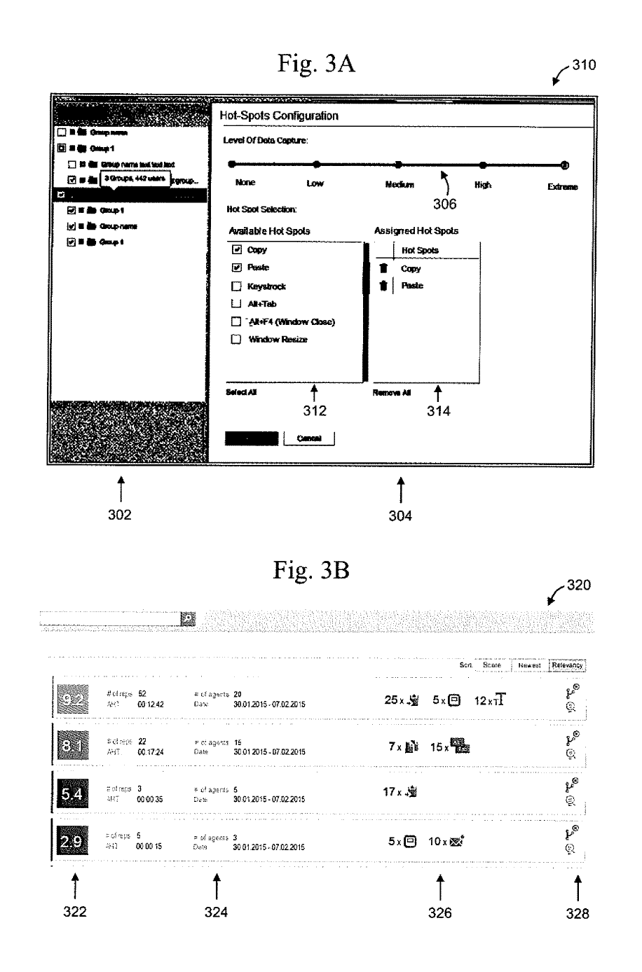

FIG. 3A illustrates a technical oriented variant of a portal as window 310, according to exemplary embodiments of the disclosed subject matter.

At a leftmost panel of window 310, indicated as a panel 302, is presented a construct for selecting users of the client computers for behavioral evaluation thereof. As depicted in panel 302, 3 groups totaling 442 users of client computers are selected for review.

At a right-central panel of window 310, indicated as a center a panel 304, is provided a slider 306 for setting the amount of data to be presented.

Further in panel 304 is provided a list 312 of captured events that are available for selection for reviewing and a list 314 of selected events to be reviewed.

FIG. 3B illustrates a business oriented variant of a portal as a window 320, according to exemplary embodiments of the disclosed subject matter.

As pointed out by an arrow 322, window 320 indicates amounts of potential savings in case inefficiencies are avoided, and as pointed out by an arrow 324, window 320 depicts some administrative information. Further, as pointed out by an arrow 326, window 320

[symbol]

depicts some symbols with associated amounts indicating what operations were performed, e.g. and [symbol] for copy and paste, respectively, and the amounts indicating repetitions thereof.

Yet further, as pointed out by and arrow 328, window 320 depicts symbols for zooming or increasing and decreasing the extent of information in window 320.

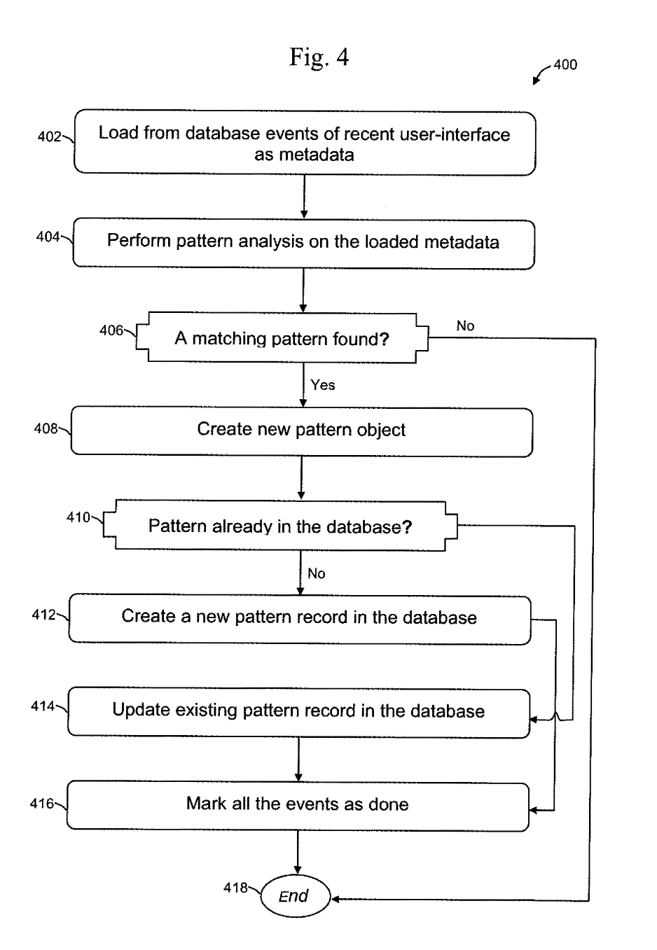

FIG. 4 outlines operations 400 in collecting user-interface for matching, according to exemplary embodiments of the disclosed subject matter.

Assuming, by way of example, that events with metadata of user-interface operations by users were recorded and provided to a storage, such as storage 122, as in a database or any suitable construct that for brevity is referred to herein as a database.

Further by way of example, pre-set or pre-configured inefficiencies are identified according to which patterns are subsequently evaluated, such as Copy/Paste, Alt-Tab (navigation for navigation between processes or application), keystrokes (including optionally identification of the keys) or idle time.

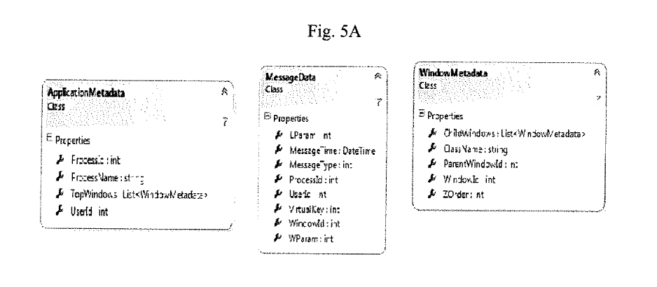

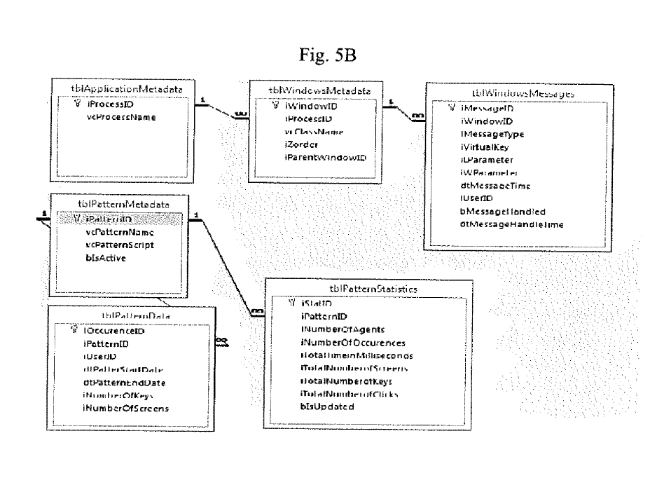

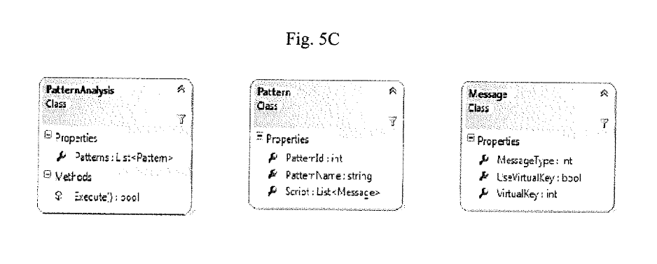

In the descriptions of some of operations 400 references are made to representative metadata regarding the user-interface events as provided below in FIG. 5A-FIG. 5C.

In operation 402 events of recent user-interface as metadata (marked by the bMessageHandled field) are loaded from the database. Generally, the events metadata are marked and/or grouped by users (indicated by the iUserId field) and according to time of occurrences of the events (as indicated by the dtMessageTime field).

In operation 404 pattern analysis is performed on the loaded data with respect to the pre-set or pre-configured inefficiencies. Generally the analysis is carried out sequentially and incrementally though other techniques may be used such as parallelly on a plurality of processors or plurality of processors cores.

In operation 406 it is checked whether an event matches the pre-set or pre-configured inefficiencies. If not match was found, then the sequence of operations 400 is ended as indicated by an oval 418; otherwise, in operation 408 a new pattern object is created and stored in the database. In some embodiments the new pattern object includes statistics of the pattern, such as number of keystrokes, number of applications accessed.

In operation 410 it is checked whether the pattern is already in the database.

if the pattern is not present in the database then in operation 412 a new pattern record is created in the database, and statistics of the pattern are obtained, such as from the respective pattern object, and stored and/or associated with the new pattern record. Otherwise, if the pattern is present in the database then in operation 414 the existing pattern record in the database is updated with the statistical information of that pattern.

Subsequently, in operation 416 the recently loaded events are marked as done or as handled, that is, not the pending for further operation in the respect of operations 400.

It is noted that operations 400 are depicted concisely to convey the basic function thereof, and in principle operations 400 might have been presented by more elementary actions within a loop, yet without adding to the core idea.

FIG. 5A illustrates objects and metadata of messages as may be appreciated in the Microsoft Windows environment; FIG. 5B illustrates relevant information regarding the present disclosure, messages that were intercepted and the patterns' meta data, samples and statistics objects and metadata of messages as may be appreciated in the Microsoft Windows environment; and FIG. 5C illustrates objects for pattern analysis service employed in searching and parsing a database for new patterns as may be appreciated in the Microsoft Windows environment.

The server, such as server 120, may comprise a plurality of computers and/or servers operating in conjunction with each other.

The monitoring code such as a code 116 may be implemented in various manners, for example as a program installed in the memory of a client computer such as computer 110, as firmware in a client computer, as remote program on a server or as any suitable technique.

Storage 122 may comprise one or more hard disks or solid state disk and me distributed such as in multiple locations having communications therebetween.

In some embodiments data provided to the server such as sever 120 may be provided directly or indirectly to storage 122 with no intervention and/or some coordination with the server.

Generally, once user-interface events or data thereof of the client computers are provided to the server or the storage the events or data thereof are discarded.

It is noted that transfer of events or data thereof from the client computers may be disrupted such as due to communications failure or bandwidth congestion. In order to maintain consistency and reliability of the data, or in other words the persistency of the data, the data in the client computes is buffered such as in storage of memory and are transferred only when viable communication is substantiated. In case communication failure occurs during transfer, once the communication is restored the buffered data is transferred. The data persistency may use techniques of the communications are such as packet numbering and/or acknowledgments.

It is noted that though generally the portal as a computer visually presents information as to the inefficiencies of the user-interface operations, yet, in some embodiments, the information is provided and/or presented in different manners such as by a print-out on a paper or in an e-book.

Considering the contemporary proliferation of computerized devices having a touch-screen, such as tablet computers and smartphones, the user-interface and/or on-screen operations include and at least do not preclude operations on a touch-screen.

For example, double-click on certain region on a touch-screen is akin to and/or equivalent to double-click with a left mouse-key, or touching on a symbol of copy such as [symbol] is equivalent to a copy operation as via an Edit menu or by ‘control/C’.

Further, considering the advent of other devices for user-interface, such as air-mouse or similar devices (e.g. Mobile Mouse by RPA Technology), operations by such devices are not precluded from the subject matter of the present application.

Further, as new technologies of handling data on a user-interface, or new techniques for user-interface may be available, operation by such devices and/or in such environment are not precluded from the subject matter of the present application.

Embodiments of the present disclosure is carried out by client computers and a server and a portal that are liked therebetween by communications facilities.

The embodiments employ and practice mechanisms of pattern matching and analysis and additionally of automation based on analysis and insights of inefficiencies.

It is noted that the mechanisms and operations as described above are complex and deal with numerous data elements. Thus, evidently and clearly the mechanisms and operations are far beyond the capabilities of humans even when aided by pencil-and-paper or calculators. Therefore, the mechanisms and operations can only be carried out by machinery such as electronic processors using integrated and/or separate devices of memory, input/output and/or other functionalities such as communications.

Further, considering expected accomplishments of the mechanisms and operations within a feasible short time of a few seconds or minutes and up to a few hours—otherwise the whole scheme might be impractical for use—implementation by a machine is obviously called for.

Consequently, undoubtedly the mechanisms and operations disclosed herein are inherently tied to a machine for the implementation thereof.

There is thus provided according to the present disclosure a computerized method for evaluating operational behavior on a computer, comprising activating in the computer a code that intercepts events of operations on a user-interface of the computer and acquires data of the events, providing the data of the events to a computerized apparatus that automatically analyzes the data of the events by employing a pattern recognition algorithm that consequently identifies inefficient operations, summarizing and adapting for manual evaluation information related to the inefficient operations, and visually presenting on a presentation device the summarized and adapted information related to the inefficient operations to accomplish an objective.

In some embodiments, the method further comprises devising procedures configured for improving efficiency of operations on the user-interface of the computer.

In some embodiments, the method further comprises incorporating the procedures on the computer for automating the operations on the user-interface of the computer.

In some embodiments, improving efficiency of operations comprises at least reducing the amount of superfluous operations.

In some embodiments, improving efficiency of operations comprises elimination of superfluous operations.

In some embodiments, improving efficiency of operations comprises simplifying of the operations.

In some embodiments, improving efficiency of operations comprises avoiding operational bottlenecks.

In some embodiments, the pattern recognition algorithm is provided with a set designated operation according to which the inefficient operations are determined.

In some embodiments, the pattern recognition algorithm is an algorithm directed to find statistically significant operational patterns.

In some embodiments, the inefficient operations comprise unnecessary repetitions of operations for achieving a task.

In some embodiments, the computer comprises a plurality of computers and accordingly the code comprises a plurality of respective codes.

There is thus further provided according to the present disclosure a computerized system for carrying out the method and/or any part thereof.

In the context of some embodiments of the present disclosure, by way of example and without limiting, terms such as ‘operating’ or ‘executing’ imply also capabilities, such as ‘operable’ or ‘executable’, respectively.

Conjugated terms such as, by way of example, ‘a thing property’ implies a property of the thing, unless otherwise clearly evident from the context thereof.

The terms ‘processor’ or ‘computer’, or system thereof, are used herein as ordinary context of the art, such as a general purpose processor or a micro-processor, RISC processor, or DSP, possibly comprising additional elements such as memory or communication ports. Optionally or additionally, the terms ‘processor’ or ‘computer’ or derivatives thereof denote an apparatus that is capable of carrying out a provided or an incorporated program and/or is capable of controlling and/or accessing data storage apparatus and/or other apparatus such as input and output ports. The terms ‘processor’ or ‘computer’ denote also a plurality of processors or computers connected, and/or linked and/or otherwise communicating, possibly sharing one or more other resources such as a memory.

The terms ‘software’, ‘program’, ‘software procedure’ or ‘procedure’ or ‘software code’ or ‘code’ or ‘application’ may be used interchangeably according to the context thereof, and denote one or more instructions or directives or circuitry for performing a sequence of operations that generally represent an algorithm and/or other process or method. The program is stored in or on a medium such as RAM, ROM, or disk, or embedded in a circuitry accessible and executable by an apparatus such as a processor or other circuitry.

The processor and program may constitute the same apparatus, at least partially, such as an array of electronic gates, such as FPGA or ASIC, designed to perform a programmed sequence of operations, optionally comprising or linked with a processor or other circuitry.

The term computerized apparatus or a computerized system or a similar term denotes an apparatus comprising one or more processors operable or operating according to one or more programs.

As used herein, without limiting, a process represents a collection of operations for achieving a certain objective or an outcome.

As used herein, the term ‘server’ denotes a computerized apparatus providing data and/or operational service or services to one or more other apparatuses.

The term ‘configuring’ and/or ‘adapting’ for an objective, or a variation thereof, implies using at least a software and/or electronic circuit and/or auxiliary apparatus designed and/or implemented and/or operable or operative to achieve the objective.

A device storing and/or comprising a program and/or data constitutes an article of manufacture. Unless otherwise specified, the program and/or data are stored in or on a non-transitory medium.

In case electrical or electronic equipment is disclosed it is assumed that an appropriate power supply is used for the operation thereof.

The flowchart and block diagrams illustrate architecture, functionality or an operation of possible implementations of systems, methods and computer program products according to various embodiments of the present disclosed subject matter. In this regard, each block in the flowchart or block diagrams may represent a module, segment, or portion of program code, which comprises one or more executable instructions for implementing the specified logical function(s). It should also be noted that, in some alternative implementations, illustrated or described operations may occur in a different order or in combination or as concurrent operations instead of sequential operations to achieve the same or equivalent effect.

The corresponding structures, materials, acts, and equivalents of all means or step plus function elements in the claims below are intended to include any structure, material, or act for performing the function in combination with other claimed elements as specifically claimed. As used herein, the singular forms “a”, “an” and “the” are intended to include the plural forms as well, unless the context clearly indicates otherwise. It will be further understood that the terms “comprises” and/or “comprising” and/or “having” when used in this specification, specify the presence of stated features, integers, steps, operations, elements, and/or components, but do not preclude the presence or addition of one or more other features, integers, steps, operations, elements, components, and/or groups thereof.

The terminology used herein should not be understood as limiting, unless otherwise specified, and is for the purpose of describing particular embodiments only and is not intended to be limiting of the disclosed subject matter. While certain embodiments of the disclosed subject matter have been illustrated and described, it will be clear that the disclosure is not limited to the embodiments described herein. Numerous modifications, changes, variations, substitutions and equivalents are not precluded.

1. A computerized method for evaluating operational behavior on a computer, comprising:
activating in the computer a code that intercepts events of operations on a user-interface of the computer and acquires data of the events;
providing the data of the events to a computerized apparatus that automatically analyzes the data of the events by employing a pattern recognition algorithm that consequently identifies inefficient operations;
summarizing and adapting for manual evaluation information related to the inefficient operations; and
visually presenting on a presentation device the summarized and adapted information related to the inefficient operations to accomplish an objective.

2. The method according to claim 1, further comprising devising procedures configured for improving efficiency of operations on the user-interface of the computer.

3. The method of according to claim 2, further comprising incorporating the procedures on the computer for automating the operations on the user-interface of the computer.

4. The method of according to claim 2, wherein improving efficiency of operations comprises at least reducing the amount of superfluous operations.

5. The method of according to claim 2, wherein improving efficiency of operations comprises elimination of superfluous operations.

6. The method of according to claim 2, wherein improving efficiency of operations comprises simplifying of the operations.

7. The method of according to claim 2, wherein improving efficiency of operations comprises avoiding operational bottlenecks.

8. The method according to claim 1, wherein the pattern recognition algorithm is provided with a set designated operation according to which the inefficient operations are determined.

9. The method according to claim 1, wherein the pattern recognition algorithm is an algorithm directed to find statistically significant operational patterns.

10. The method according to claim 1, wherein the inefficient operations comprise unnecessary repetitions of operations for achieving a task.

11. The method according to claim 1, wherein the computer comprises a plurality of computers and accordingly the code comprises a plurality of respective codes.

12. A computerized system for carrying out the method according to claim 1.
